(19) United States
(12) Patent Application Publication
(10) Pub. No.: US 2020/0117443 A1
(43) Pub. Date: Apr. 16, 2020

(54) SELECTIVE APPLICATION UPDATES BASED ON USAGE ANALYTICS

(71) Applicant: CA, Inc., New York, NY (US)

(72) Inventors: Vikrant Nandakumar, Bangalore (IN); Rohit Pathak, Bangalore (IN); Lyju Rappai Vadassery, Mumbai (IN); Vijay Shashikant Kulkarni, Bangalore (IN)

(21) Appl. No.: 16/160,652

(22) Filed: Oct. 15, 2018

(51) Int. Cl. G06F 8/658

(52) U.S. Cl. CPC G06F 8/658

(57) ABSTRACT

To prevent utilization of device storage space for storage of application updates affecting features which a user does not use, selective application updates are offered on a per-feature, per-user basis based on analysis of monitored application use patterns. Application analytics software monitors user behavior and interaction with the application and uploads usage metrics to an application store server (“server”). The server determines for each user the features for which a high, low, or no usage activity has been observed. The server maintains data structures to correlate code units with application features. The server determines which application features are impacted by updates to the application source code based on correlations indicated in the data structures. The server determines if a user's device should receive an auto-update or a notification that an update is available if the application update affects the features for which high user activity has been observed.

### BACKGROUND

The disclosure generally relates to the field of data processing, and more particularly to software development, installation, and management.

A developer pushes an updated build of a software application to an application store to make new and/or updated application features available for download. A new version of the application which contains the new and/or updated application features can be downloaded and installed to a device. A user may receive a notification that an updated version of the application has become available for download. The user can manually download the updated version of the application or elect to have the updated version of the application pushed to the device as application updates become available (“auto-updates”). The user may further choose to only receive auto-updates when the device has established an Internet connection.

### BRIEF DESCRIPTION OF THE DRAWINGS

Embodiments of the disclosure may be better understood by referencing the accompanying drawings.

FIG. 1 depicts an application update manager which analyzes application usage metrics collected from users and offers application updates based on frequency of use of application features.

FIG. 2 is a flowchart of example operations for analyzing usage metrics to determine if a user should receive an application update.

FIG. 3 depicts an example computer system with an application update manager.

### DESCRIPTION

The description that follows includes example systems, methods, techniques, and program flows that embody aspects of the disclosure. However, it is understood that this disclosure may be practiced without these specific details. For instance, this disclosure refers to receiving application files (e.g., executables, directories, application resources and assets, etc.) in a package file in illustrative examples. Aspects of this disclosure can be also applied to any file format which supports storing and sending/receiving application files as a unit (e.g., application bundles). In other instances, well-known instruction instances, protocols, structures and techniques have not been shown in detail in order not to obfuscate the description.

### Overview

Application updates which have been pushed to a digital distribution platform for software (an application store or “app marketplace”) often affect particular application features and/or application flows. After a user downloads an update for an application from an application store to a device, each component of the application update is installed to the device regardless of the frequency with which the user interacts with the affected application features. To prevent utilization of device storage space for storage of application updates affecting features which a user does not use, selective application updates are offered on a per-feature, per-user basis based on analysis of monitored application use patterns.

The disclosed technology leverages application analytics software. Application analytics software monitors user behavior and interaction with the application and uploads usage metrics to an application store server (“server”). The server can determine for each user the features for which a high amount of user activity has been observed as well as the features for which a lower amount of or no user activity has been observed. Additionally, the server maintains data structures to correlate code units (e.g., code units) with application features. When a developer pushes a new version of the application to the application store, the server can determine which application features are impacted by updates to the application code based on the correlations indicated in the data structures. The server then determines if a user's device should receive an auto-update or a notification that an update is available if the application update affects the features for which high user activity has been observed. If an update impacts multiple features with varying degrees of observed user activity, components of the update may be selected individually based on usage metrics and provided for download as a new build of the application.

### Example Illustrations

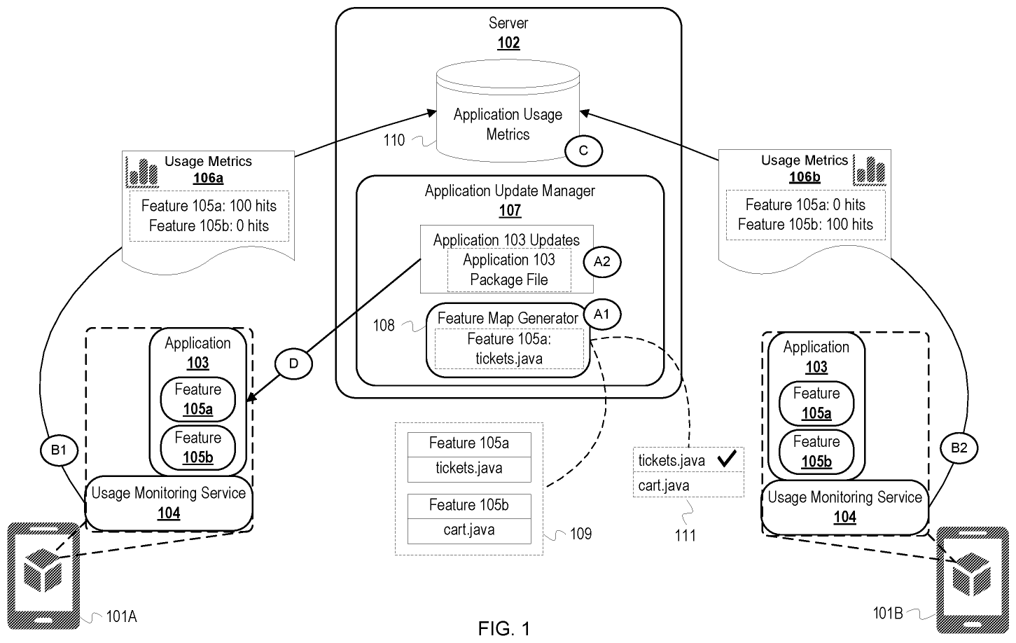

FIG. 1 depicts an application update manager which analyzes application usage metrics collected from users and offers application updates based on frequency of use of application features. FIG. 1 depicts devices 101a and 101b on which an application 103 is installed. A usage monitoring service 104 (“monitoring service 104”) collects usage metrics 106a for the application 103 executing on the device 101a and usage metrics 106b for the application 103 executing on the device 101b. The usage monitoring service 104 can be an operating system level service that has visibility of application interactions via human interface devices (HIDs) and screen flows. Each installed instance of the monitoring service 104 reports the usage metrics 106a-b to an application store server 102 (“server 102”). The server 102 maintains an application usage metrics repository 110 (“metrics repository 110”) which stores the usage metrics 106a-b which have been collected for each user of the application 103. The application 103 includes features 105a and 105b. The features 105a-b can be modules of the application 103 which provide particular functionality and may include at least one screen flow in which screens of the application 103 are sequentially presented to the user in response to user interaction. For instance, upon selection of a button corresponding to one of the features 105a-b, the functionality of the feature 105a or 105b may be presented to the user either directly in response or by sequentially presenting each screen of the screen flow. An application update manager 107 analyzes the usage metrics 106a-b corresponding to each of the features 105a-b to determine which updates to the application 103 should be offered to the users of the devices 101a-b.

FIG. 1 is annotated with a series of letters A1-D. These letters represent stages of operations. Although these stages are ordered for this example, the stages illustrate one example to aid in understanding this disclosure and should not be used to limit the claims. Subject matter falling within the scope of the claims can vary with respect to the order and some of the operations.

At stage A1, after the server 102 receives a package file 111 containing code units (e.g., source code files, library files, routines and/or subroutines, etc.) for the application 103, the feature map generator 108 inspects contents of the package file 111 to determine updates to the application 103. The feature map generator 108 unpacks the package file 111 to identify the code units which have been received. The feature map generator 108 creates a feature map 109 which associates each of the code units of the package file 111 with the features 105a-b of the application 103. The feature map 109 organizes the code units by functionality by indicating the code units on which the functionality of each of the features 105a-b depends. The feature map 109 maps each of the code units to the application features 105a-b and can be created on a screen flow-by-screen flow basis (e.g., mapping each code unit upon which the functionality of each page or section of a screen flow associated with a feature is dependent). The feature map generator 108 leverages information obtained from the integrated development environment (IDE) in which the application 103 was developed to identify the code units corresponding to the functionality of particular sections and/or screen flows of the application 103 (e.g., business logic, user interface logic, etc.). For instance, the entry for the feature 105b maintained in the feature map 109 should include each file which supports the screen flow for each possible screen presented for the feature 105b. As an example, if the feature 105b is a shopping feature and its screen flow includes a products screen which leads to a checkout screen, the code units corresponding to both the products screen and the checkout screen will be correlated with the feature 105b in the feature map 109. The feature map 109 for the application 103 includes code units which are responsible for screen flow-specific functionality for the features 105a-b and/or code units which support general functionality of and interaction with the application 103.

At stage A2, the application update manager 107 uses the feature map 109 to determine which of the features 105a-b have been impacted by the update to the application 103 as a result of modification of at least one of the code units on which the feature 105a or 105b depends. For example, in FIG. 1, the application update manager 107 determines that the source code file tickets.java has been modified in the application 103 update. The application update manager 107 checks the feature map 109 to identify which of the features 105a-b depend on tickets.java. The application update manager 107 identifies that tickets.java maps to the feature 105a in the feature map 109 and thus determines that the feature 105a has been affected by the update.

At stages B1 and B2, the usage monitoring service 104 executing on each of the devices 101a-b monitors user interaction with the application 103 on each of the devices 101a-b. Although seemingly subsequent to stages A1 and A2, the operation represented by stages B1 and B2 being prior to an update and can be concurrent with the operations of stages A1 and A2. The usage monitoring service 104 can be instantiated based on an operating system-specific application programming interface (API) or software development kit (SDK) installed on the devices 101a-b which provides application 103 analytics for a digital distribution platform. The collected usage metrics 106a-b are uploaded to the server 102 for storage in the metrics repository 110. The usage metrics 106a-b may include the number of times a user has visited a section of the application 103, amount of time a user has spent on a screen of the application 103, the particular screens of a screen flow which a user navigated after selecting one of the features 105a-b, etc. For example, the usage metrics 106a collected for the user of the device 101a indicate that the user visited application 103 screens and/or screen flows corresponding to the feature 105a 100 times and did not use the feature 105b. The usage metrics 106b indicate that the user of the device 101b did not use the feature 105a and visited application 103 screens and/or screen flows corresponding to the feature 105b 100 times. Feature usage can be defined on a screen flow-by-screen flow basis (i.e., with respect to interaction with and navigation between screens to create the screen flow associated with the feature). For example, the usage metrics 106a depict that the feature 105a received 100 hits. The 100 hits may correspond to the number of times the feature 105a was selected as well as the number of times the user of the device 101a navigated through screen flows of the feature 105a.

The server 102 can be configured to collect the usage metrics 106a-b from the usage monitoring service 104 periodically (e.g., in predetermined time increments, when an application 103 update has been pushed to the server 102, when the application 103 is executing as a background application, etc.). The metrics repository 110 may also store metrics collected from monitoring of multiple applications which are supported by the server 102. The server 102 therefore may support one application update manager (e.g., the application update manager 107) which manages application updates for each application for which usage metrics are collected and stored in the metrics repository 110. The server 102 may also support multiple application update managers, each of which manage application updates for an individual application (e.g., the application 103).

At stage C, the application update manager 107 examines the usage metrics collected for each user of the application 103 to identify which of the features impacted by the update satisfy an update criterion for each user. The update criterion can be a threshold frequency of use for a feature at which the update to the feature may be considered relevant to a user. The update criterion can also correspond to a usage indicator which may be assigned to the features 105a-b based on analysis of the usage metrics 106a-b (e.g., assigning the feature 105a with an indicator corresponding to a high frequency of use for the user of the device 101a). For example, the application update manager 107 may enforce a threshold of 50 hits for screens of each of the features 105a-b which should be achieved to consider an update which affects each of the features 105a-b to be pertinent. The update manager 107 can query the application usage metrics repository 110 with the update criterion or criteria and an indication of feature(s) impacted by the update as search constraints or parameters. The results yielded from the query can be a listing of device identifiers, user account identifiers, etc. Based on a determination that the feature 105a is affected by the update, the application update manager 107 examines the usage metrics 106a-b to identify the devices 101a-b for which the usage criterion is satisfied. If the repository 110 is not organized to allow the application update manager 107 to query on per feature statistics of use, then the application update manager 107 can query the repository 110 based on application identifier and examine the returned statistics. By comparing the observed use of the feature 105a for the devices 101a-b with the usage threshold of 50 hits, the application update manager 107 determines that the update criterion for feature 105a is satisfied for the device 101a, but not for the device 101b.

At stage D, the application update manager 107 provides the device 101a with the update to the feature 105a for download as a result of satisfying the update criterion. The device 101b does not automatically receive the update to feature 105b because the observed use of the feature 105b based on the usage metrics 106b did not satisfy the update criterion. The application update manager 107 can provide the update affecting feature 105a by notifying the user of the device 101a that an update is available in the application store (e.g., with a push notification, banner notification, etc.) or, if the user of the device 101a has opted to receive auto-updates, can push the ticket.java update to the device 101a. Alternatively, the application update manager 107 can make the ticket.java update available to the device 101a for download and the device 101a can pull the update from the application update manager 107 for download and installation upon identifying that an update to the application 103 is ready for download. A preference by the developer and/or a user can also be set to disallow incremental updates while still allowing selective updates. For instance, device 101a may download and install the update package file 111 based on the affect to feature 105a. Thus, the device 101a will also receive the cart.java code unit despite it affecting the feature 105b. This allows selective updating at different granularities.

To provide the update to the device 101a, the application update manager 107 determines which download option the user of the device 101a has selected. Different download options are available to allow users of the devices 101a-b to receive selective updates to the application 103 after the updates are pushed to the application store. Application updates are offered to users based on user preference to ensure optimal efficiency of use of storage space on the devices 101a-b and to reduce the frequency with which users are prompted to download new application 103 updates. To facilitate selection of a download option, the server 102 compiles application 103 usage statistics based on aggregation of the usage metrics 106a-b which have been collected from each of the devices 101a-b. The application 103 usage statistics are presented with the application 103 download page on the application store. For instance, the usage statistics may indicate an average frequency of use of each of the application 103 features which are impacted by the most recent update.

Users may elect to receive auto-updates for updates which a developer has indicated are necessary for application 103 functionality (e.g., bug fixes) or updates which impact the features determined to be most frequently used on a per-user basis. Users may also choose to opt out of any updates which do not impact the features failing to satisfy the update criterion. As depicted in FIG. 1, the user of the device 101b might have opted out of receiving the update to the application 103 which affected the feature 105a because the usage of the feature 105a did not satisfy the update criterion and the feature 105b was not affected by the update. Alternatively, users can elect to only receive auto-updates or notifications for mandatory updates to the application 103 (e.g., vulnerability patches). The download options may be further refined to indicate if a user will only be provided with the updates limited to particular features which satisfy the update criterion (e.g., the updates which affect the feature 105a) or if a user will receive a full update. For instance, a module containing only the update to the feature 105a may be pushed to the device 101a, and a new build of the application 103 will be created locally on the device 101a. The server 102 may alternatively generate the new build for the application 103 which includes the full update before pushing the built application 103 to the device 101a.

Users can opt to receive selective application updates without consenting to usage monitoring and usage metrics collection. If a user has opted out of usage metrics collection and the metrics database 110 therefore does not have usage metrics for user interaction with the application 103, the application update manager 107 may provide updates based on analysis of the usage statistics. For instance, if the usage statistics indicate that a newly updated feature has a high frequency of use for the majority of users of the application 103, the application update manager 107 may provide the update to the user for download. Similarly, if the usage statistics indicate that a newly updated feature has a significantly low frequency of use for the majority of users of the application 103, the application update manager 107 may not provide the update to the user for download.

In an embodiment, users may select a manual custom update option for receiving updates to the application 103. With the manual custom update option, users build a custom package file for the application 103 by selecting which of the updated features 105a-b will be downloaded and installed on the devices 101a-b. The resulting package file is built at the server 102 before being provided for download. For example, the user of the device 101b may opt to download the update to the feature 105a despite not satisfying the usage criterion for the update. The user of the device 101b then selects the feature 105a from a list of available updates to the features 105a-b. The server 102 generates the build of the application 103 update which includes the update to the feature 105a and pushes the update to the device 101b for download and installation.

Though not depicted in FIG. 1, instead of pushing the package file 111 which contains both the modified and unmodified files for the application 103 to the server 102, a developer may package the updated application 103 files separately to create an update package file. The update package file which is pushed to the server 102 contains only the updated files that contribute to the updated version of the application 103. Upon receipt of an update package file, the operations depicted from stages A1-D occur as depicted in FIG. 1 with the exception of determining which code units have been updated at stage A2.

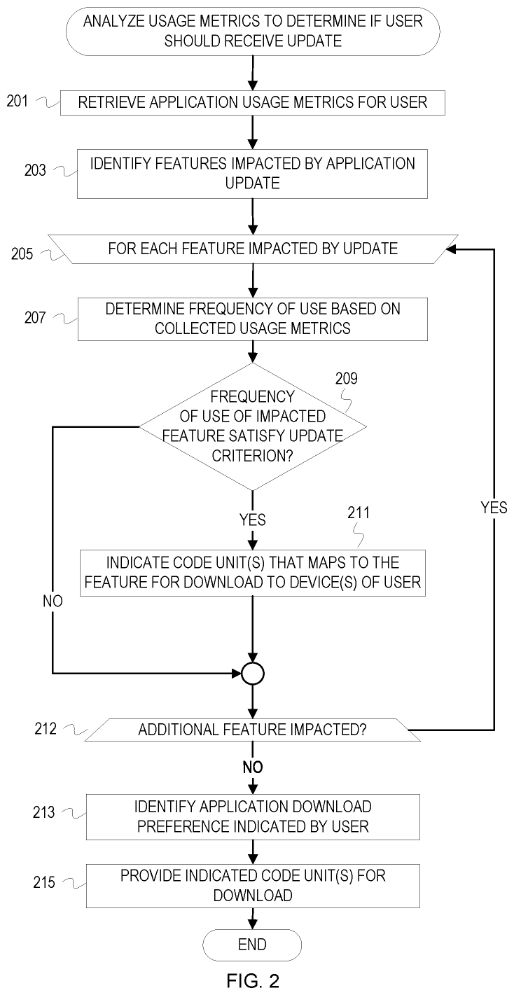

FIG. 2 is a flowchart of example operations for analyzing usage metrics to determine if a user should receive an application update. The application update is pushed to an application store server and may include the collection of application files (e.g., in an application package file) or a subset of application files which have been modified or added for the update. Usage metrics which have been collected for users of an application are stored in a metrics repository. The update manager can query the repository to retrieve the usage metrics for an application. While selective update based on feature use can be at different granularities (e.g., entire update if it impacts any qualifying feature), the example operations of FIG. 2 relate to a finer granularity of selection (e.g., usage based component selection from an update). The example operations refer to an update manager as performing the depicted operations for consistency with FIG. 1, although naming of software and program code can vary among implementations.

The update manager retrieves application usage metrics for a user account or device depending upon how the usage data is identified (201). The update manager begins the analysis for selective application update after an update becomes available on a digital distribution platform. After an update becomes available (e.g., is loaded onto a server of the distribution platform), the update manager may begin based on the state of the update or may further wait to act until it detects an update query from a device. For example, when an application is accessed on a device, the operating system may query the digital distribution platform corresponding to the application for any updates. The update manager may detect this query. The usage metrics have been obtained by an operating-system level analytics application which monitors application use on the user's device and reports collected usage metrics to a server for storage in the metrics repository. The update manager retrieves the usage metrics from the metrics database when application files which include the update are received. Application usage metrics may include time spent on different screens of the application, screen flows of the application which the user navigated, the number of times the user selected control elements (e.g., in page links, buttons, etc.).

The update manager identifies the features which are impacted by the application update (203). The update manager first identifies which application files have been modified in the update. Code units in the update may be packaged or bundled as feature-specific modules (e.g., updates to an existing feature are packaged as a first module and updates which contribute to a new feature are packaged as a second module). If the update manager has received the full set of application files (e.g., a complete application package file), the update manager identifies differences between the previous versions of the application and the received update. If the update manager identifies at least one difference between a previous code unit and a received code unit or if a code unit which has been received was not present in the previous version of the application, the update manager determines that the code unit has been updated. After identifying the updated code units, the update manager checks a feature map to determine which features correspond to each of the updated files identified and have therefore been impacted by the application update. The feature map correlates each application feature with the individual code units upon which the feature functionality depends. For example, a cart.java file may map to both a “shopping” feature and a “checkout” feature in the feature map. The update manager would thus identify that the “shopping” and “checkout” features are affected by an update to the cart.java file.

The update manager examines each feature impacted by the update (205). The feature which is currently being examined is hereinafter referred to as the “current feature.” The update manager determines a frequency of use of the current feature by analyzing the usage metrics collected for the user (207). To determine which subset of the usage metrics corresponds to the current feature, the update manager can identify the screen flows and/or sections of the application associated with the current feature. The update manager can then identify the usage metrics which were collected for the identified screen flows and/or sections of the application. For example, the feature map may define a selectable icon and a resulting screen flow for the “shopping” feature. Metrics obtained from monitoring user interaction with the selectable icon as well as each screen of the screen flow may then be identified as corresponding to the “shopping” feature. The update manager can define usage thresholds corresponding to varying degrees of frequency of use of the current feature for the types of usage metrics which have been collected. For instance, the usage thresholds may indicate an amount of usage of the current feature corresponding to high, medium, low, and no frequency based on a combination of observed navigation of one of a screen flow for the current feature and the amount of time spent on the screens within the screen flow. As an example, the thresholds may correspond to a minimum number of clicks between screens within the screen flow and a minimum amount of time spent on one or more screens within the screen flow. The frequency of use may then be determined based on satisfaction of the usage thresholds. Frequency of use may also be based on generation and analysis of a heat map for each application screen. Frequency of use may be defined on a per-application basis or may be defined across multiple applications (e.g., applications belonging to a same category on the application store).

Based on the analysis of the usage metrics for the current feature, the update manager determines whether the usage metrics of the current feature satisfy an update criterion (209). The update criterion establishes a minimum frequency of use of a feature in order to consider the update as it impacts the feature to be relevant to the user. For instance, an update which impacts a feature with a low observed frequency of use or no use is unlikely to impact the user experience when the user interacts with the application. It therefore may be an inefficient use of resources to download and install the update which affects the infrequently used features. However, an update which affects a feature with a high observed frequency of use is likely to impact the user experience when the user interacts with the application. The update criterion can be a particular frequency of use which has been assigned to a feature (e.g., if the feature is categorized as having a high frequency of use), a threshold frequency of use (e.g., if the observed interaction with the feature qualifies as at least a medium frequency of use), etc. The update criterion can also be a threshold frequency of use based on individual usage metrics which have been collected (e.g., a threshold number of times the feature is selected, a threshold frequency of navigation of a screen flow, etc.). Multiple update criteria may also be enforced which consider a combination of frequency of use and/or usage metrics thresholds. In addition, a code unit may be specified as required or necessary by the developer regardless of the usage statistics analysis.

If the current feature satisfies the update criterion based on the usage metrics analysis, the update manager indicates the one or more code units that map to the feature for application download (211). After determining that an impacted feature satisfies the update criterion, the update manager can indicate the code unit(s) corresponding to the feature by “marking” the code unit(s). Marking a code unit may be implemented by maintaining an in memory list of the code unit(s) of an update that correspond to features that satisfy the update criterion. Marking a code unit may be implemented by moving corresponding code units into a directory or folder to be packaged separately for device download. If the update manager determines that the entire update package is relevant (i.e., all code units impact features that satisfy the criterion), then no repackaging would be performed.

The update manager examines the remaining features which have been impacted by the update (212). Once each impacted feature has been examined, the update manager will have completed a usage analysis for each feature which is affected by the update to the application.

After determining content of the application update relevant to impacted features that satisfy the update criterion, the update manager identifies application download preferences which the user has indicated (213). When the user first downloads the application from the application store, the application store may present update preferences for when updates to the application are available for download. The update preferences indicate when the user should receive an auto-update or a notification that the update is available. For instance, users can opt to receive auto-updates for all updates or only for updates which affect the features satisfying the usage criterion. Users can also opt to receive auto-updates only for updates which are indicated as mandatory (e.g., updates with security patches). Alternatively, the user can choose to build a custom application package file for download (e.g., with the Google Play Dynamic Delivery option for Android). For example, the user may want to receive an application update which contains a particular selection of features regardless of whether or not each feature satisfied the usage criterion. The user can then select the desired features for creation of a new application package file which is built at the server and offered for download.

The update manager provides the qualifying components of the update for download (215). The components of the update are identified based on the update preference which the user indicated. For instance, if the user opted to receive updates each time an update affected a feature for which the usage criterion was satisfied, and the update impacted more than one of such features, the update manager will provide the update to the user. The update manager can generate a build of the application which contains the components of the update for subsequent download and installation. Alternatively, the components of the update may be downloaded to the user's device, where the application will be built with the components of the update locally for subsequent installation. The application update manager may push the updated application or components of the update to the user's device for download and installation. The application update manager may instead make the updated application or components of the update available so that the update may be pulled from the application update manager for download and installation on the user's device.

### Variations

The examples often refer to an “application update manager.” The application update manager is a construct used to refer to implementation of functionality for determining which application updates should be offered to a user based on analysis of user interaction with application features. This construct is utilized since numerous implementations are possible. An application update manager may be a particular component or components of a machine (e.g., a particular circuit card enclosed in a housing with other circuit cards/boards), machine-executable program or programs, firmware, a circuit card with circuitry configured and programmed with firmware, etc. The term is used to efficiently explain content of the disclosure. Although the examples refer to operations being performed by an application update manager, different entities can perform different operations.

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. For example, with respect to FIG. 2, the operations depicted in blocks 201 and 203 can be performed in parallel or concurrently. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine readable medium(s) may be utilized. The machine readable medium may be a machine readable signal medium or a machine readable storage medium. A machine readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine readable storage medium may be any tangible medium that can contain, or store a program for use by or in connection with an instruction execution system, apparatus, or device. A machine readable storage medium is not a machine readable signal medium.

A machine readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine readable signal medium may be any machine readable medium that is not a machine readable storage medium and that can communicate, propagate, or transport a program for use by or in connection with an instruction execution system, apparatus, or device.

Program code embodied on a machine readable medium may be transmitted using any appropriate medium, including but not limited to wireless, wireline, optical fiber cable, RF, etc., or any suitable combination of the foregoing.

Computer program code for carrying out operations for aspects of the disclosure may be written in any combination of one or more programming languages, including an object oriented programming language such as the Java® programming language, C++ or the like; a dynamic programming language such as Python; a scripting language such as Perl programming language or PowerShell script language; and conventional procedural programming languages, such as the “C” programming language or similar programming languages. The program code may execute entirely on a stand-alone machine, may execute in a distributed manner across multiple machines, and may execute on one machine while providing results and or accepting input on another machine.

The program code/instructions may also be stored in a machine readable medium that can direct a machine to function in a particular manner, such that the instructions stored in the machine readable medium produce an article of manufacture including instructions which implement the function/act specified in the flowchart and/or block diagram block or blocks.

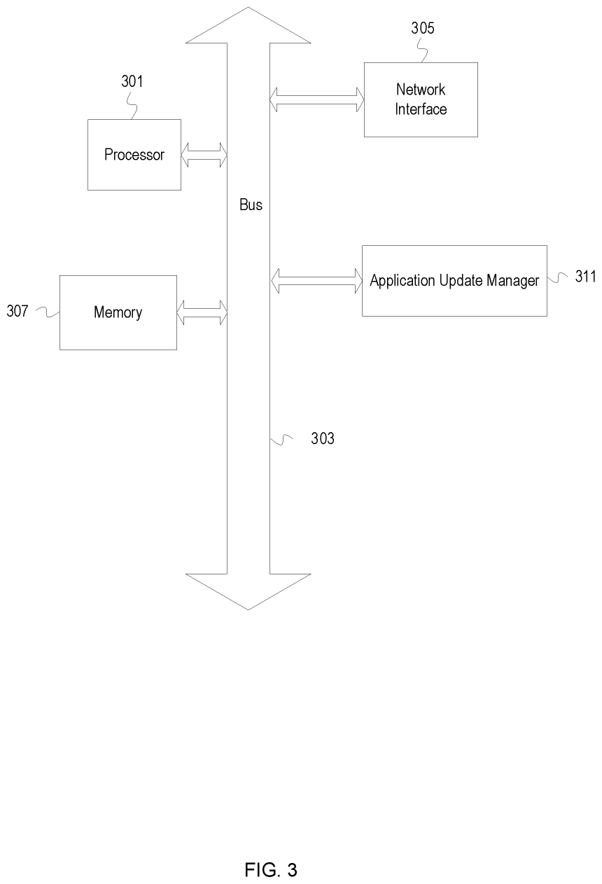

FIG. 3 depicts an example computer system with an application update manager. The computer system includes a processor 301 (possibly including multiple processors, multiple cores, multiple nodes, and/or implementing multi-threading, etc.). The computer system includes memory 307. The memory 307 may be system memory or any one or more of the above already described possible realizations of machine-readable media. The computer system also includes a bus 303 and a network interface 305 (e.g., wireless interface, wired interface, etc.). The system also includes application update manager 311. The application update manager 311 provides selective application updates to users based on analysis of collected application usage metrics for each defined application feature. Any one of the previously described functionalities may be partially (or entirely) implemented in hardware and/or on the processor 301. For example, the functionality may be implemented with an application specific integrated circuit, in logic implemented in the processor 301, in a co-processor on a peripheral device or card, etc. Further, realizations may include fewer or additional components not illustrated in FIG. 3 (e.g., video cards, audio cards, additional network interfaces, peripheral devices, etc.). The processor 301 and the network interface 305 are coupled to the bus 303. Although illustrated as being coupled to the bus 303, the memory 307 may be coupled to the processor 301.

While the aspects of the disclosure are described with reference to various implementations and exploitations, it will be understood that these aspects are illustrative and that the scope of the claims is not limited to them. In general, techniques for selectively providing application updates to users based on analysis of application usage metrics as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosure.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

What is claimed is:

1. A method comprising:
identifying a first subset of one or more of a plurality of features affected by a first update to a first application, wherein the plurality of features is of the first application;
determining whether first usage statistics of the first subset of features for a first user satisfy an update criterion, wherein usage statistics of the plurality of features have been previously collected from at least a first device on which the first application is installed and which is associated with the first user;
based on a determination that the first usage statistics of a first feature in the first subset satisfy the update criterion, identifying a first code unit in the first update that corresponds to the first feature; and
providing the first code unit for update of the first application on the first device.

2. The method of claim 1, wherein identifying the first code unit comprises determining which code units of the first application map to the first feature and identifying the first code unit as being a modified version of at least one of the code units that map to the first feature.

3. The method of claim 1, wherein identifying the first code unit comprises determining that information in the first update indicates a correlation between the first code unit and the first feature.

4. The method of claim 1 further comprising creating a feature map which correlates code units of the first update with the plurality of features.

5. The method of claim 1, wherein providing the first code unit for update of the first application on the first device comprises indicating the first code unit from a server to the first device for download and installation.

6. The method of claim 5, wherein indicating the first code unit to the first device for download and installation comprises building an update to the first application with the first code unit at the server and pushing the update to the first application to the first device.

7. The method of claim 5, wherein indicating the first code unit to the first device for download and installation comprises pushing the first code unit to the first device for local building of an update to the first application with addition of the first code unit.

8. The method of claim 1 further comprising querying a repository with search constraints of an identifier of the first user and an identifier of the first application to obtain.

9. The method of claim 1, wherein providing the first code unit for update comprises modifying the first update to remove a second code unit based on a determination that the second code unit corresponds to a second feature with second usage statistics that do not satisfy the update criterion.

10. The method of claim 9, further comprising determining that the second usage statistics for the second feature do not satisfy the update criterion and identifying the second code unit of the first update as corresponding to the second feature.

11. The method of claim 1, further comprising identifying a plurality of code units in the first update and then determining correlations between the plurality of code units and the plurality of features.

12. The method of claim 1 further comprising limiting providing of the first update to devices associated with users for which usage statistics of at least one of the first subset of features satisfies the update criterion.

13. A non-transitory, computer-readable medium having instructions stored thereon that are executable by a computing device to perform operations comprising:
determining which of a plurality of features is affected by an update to a first application, wherein the plurality of features is of the first application;
determining whether first user dependent usage statistics of those of the features affected by update satisfy an update criterion, wherein second user dependent usage statistics of the first application have been previously collected from at least a first device on which the first application is installed and the second user dependent usage statistics include the first user dependent usage statistics; and
based on a determination that the first user dependent usage statistics of at least a first affected feature satisfy the update criterion, providing at least a part of the first update for updating the first application on the first device.

14. The computer-readable medium of claim 13, further comprising detecting availability of the update to the first application, wherein determining which of the plurality of features is affected by the update is based on detecting availability of the update.

15. The computer-readable medium of claim 13, further comprising identifying a first code unit that maps to the first affected feature based, at least in part, on determining that the first user dependent usage statistics for the first affected feature satisfy the update criterion, wherein providing at least part of the first update comprises providing the first code unit identified as mapping to the first affected feature.

16. The computer-readable medium of claim 15, wherein identifying the first code unit comprises determining which code units of the first application map to the first affected feature and identifying the first code unit as being a modified version of at least one of the code units that map to the first affected feature.

17. The computer-readable medium of claim 15, wherein identifying the first code unit comprises determining that information in the update indicates a correlation between the first code unit and the first affected feature.

18. An apparatus comprising:
a processor; and
a computer-readable medium having instructions stored thereon that are executable by the processor to cause the apparatus to,
determine which of a plurality of features is affected by an update to a first application, wherein the plurality of features is of the first application;
determine whether one or more affected features satisfies an update criterion based, at least in part, on first user dependent usage statistics of the one or more affected features, wherein second user dependent usage statistics of the first application have been previously collected from at least a first device on which the first application is installed and the second user dependent usage statistics include the first user dependent usage statistics; and
based on a determination that the first user dependent usage statistics of at least a first affected feature satisfy the update criterion, provide at least a part of the first update for updating the first application on the first device.

19. The apparatus of claim 18, wherein the computer-readable medium further has instructions executable by the processor to cause the apparatus to detect availability of the update to the first application, wherein determination of which of the plurality of features is affected by the update is based on detection of availability of the update.

20. The apparatus of claim 18, wherein the computer-readable medium further has instructions executable by the processor to cause the apparatus to identify a first code unit that maps to the first affected feature based, at least in part, on a determination that the first user dependent usage statistics for the first affected feature satisfy the update criterion, wherein the instructions to provide at least part of the first update comprise instructions executable by the processor to cause the apparatus to provide the first code unit identified as mapping to the first affected feature.
